(19) United States
(12) Patent Application Publication
(10) Pub. No.: US 2022/0385605 A1
(43) Pub. Date: Dec. 1, 2022

(54) MANAGEMENT OF MESSAGE THREADS GENERATED FROM AN INTRA-MESSAGE SPLIT

(71) Applicant: MICROSOFT TECHNOLOGY LICENSING, LLC, Redmond, WA (US)

(72) Inventors: Amer Aref HASSAN, Kirkland, WA (US); Mahendra D. SEKARAN, Sammamish, WA (US); Scott Edward VAN VLIET, Ladera Ranch, CA (US)

(21) Appl. No.: 17/332,877

(22) Filed: May 27, 2021

(51) Int. Cl. H04L 12/58; G06F 40/279; G06F 3/048

(52) U.S. Cl. CPC H04L 51/16; G06F 40/279; G06F 3/048

(57) ABSTRACT

The techniques disclosed herein provide a system that can display messages from an original thread and activate a split of the original thread by splitting content of a single message into the two threads. For instance, if a single message within a chat thread is related to two topics, the system can split the content of the single message into separate portions and associate the portions into two different chat threads that are respectively related to two different topics. In response to a division of a single message, the system can parse portions of the message by topic and use that parsed content to generate messages in child threads. The child threads can each use customized topics and each child thread can be generated using content from messages of the original thread.

### BACKGROUND

There are a number of different types of collaborative systems that allow users to communicate. For example, some systems allow people to collaborate by sharing meeting chat messages, group chat messages, emails, etc. Although these systems can be useful for allowing users to coordinate and share ideas, some existing systems have a number of drawbacks. For instance, some systems do not organize messages in a way that allows users to optimally manage large amounts of information. When a user has a number of text-based conversations with different groups of people, it may be difficult for a user to monitor each conversation. This can be particularly difficult when a user has several topics within each chat thread. When managing many message threads, users can become unaware of the different topics being discussed, and miss important content and tasks.

Such shortcomings can lead to an inefficient user interaction model and lead to inefficient use of computing systems. If users miss salient information within a conversation, that causes users to produce redundant messages, prolonged meetings or other duplicated efforts to review missed content, which can lead to redundant use of network resources, storage resources, and processing resources.

### SUMMARY

The techniques disclosed herein provide a message thread management system that allows users to split message threads into child message threads. In some configurations, a system can display messages from an original thread and activate a split of the original thread by splitting content of a single message into the two threads. For instance, if a single message within a chat thread is related to two topics, the system can split the content of the single message into separate portions and associate the portions into two different chat threads that are respectively related to two different topics. A selection of a single message from an original thread can be split can be based on one or more factors, including a user input or attributes of the message. In response to a division of a single message, the system can parse portions of the message by topic and use that parsed content to generate messages in child threads. The child threads can each use customized topics and each child thread can be generated using content from messages of the original thread.

In some configurations, the system can select a single message to be split based on an input indicating a particular message. The system can also select a single message for analysis based on attributes of each message. For instance, the system can select a message based on a time associated with the message, a position of the message within a user interface, the identification of select content in the message, or formats of the message. Once a message is selected, the system performs an analysis of the content of the message to determine if two or more topics are present, e.g., if the message is a multi-topic message. Responsive to determining that a selected message comprises two or more topics, the system causes a split of the selected message and generates two or more new child threads. Each child thread can be associated with an identified topic name and each may have messages containing a portion of the selected message. Each portion of the selected original message can be associated with messages in individual child threads each corresponding to a respective topic name. The system can also analyze other messages within the original thread to organize the remaining messages between the child threads.

The techniques disclosed herein can provide a number of technical benefits. For instance, by providing a display of messages that are organized in individual threads according to topics discovered within a single message, a computing device can effectively display information in a format that can allow a granular level of control of how content is organized. In addition, by allowing a system to split a single message into different threads, the system can more accurately identify topics and sort messages that are appropriate for each topic. Without the ability to split messages that pertain to multiple topics, a system may have to duplicate that message for between the new child threads. Specifically, existing systems that do not split a multi-topic message may place the message in a thread with a topic that does accurately align with the content of a multi-topic message. Alternatively, some existing systems may just place multi-topic messages in multiple threads. In either case, some existing systems do not allow for a granular level of accuracy when aligning each child thread topic with each multi-topic message. This can lead to user confusion when users are reading the new threads with inaccurate topic titles. These issues with existing systems also lead to a duplicative use of computing resources for storing some multi-topic messages in multiple threads.

When implementing the techniques disclosed herein, when a multi-topic message is split to more accurately align the message content with new child topics, a system can also increase the efficiency of a user's interaction with a device. When information is organized more accurately a user is less likely to miss salient information. Such benefits can increase the efficiency of a computing system by reducing the number of times a user needs to interact with a computing device to obtain information, e.g., prolonging meetings, retrieving meeting recordings, requesting duplicate copies of previously shared content, etc. Thus, various computing resources such as network resources, memory resources, and processing resources can be reduced.

The efficiencies of the analysis of a select message can also lead to other efficiencies. In particular, by displaying messages more accurately within topics, a system can reduce the number of times a user needs to interact with a computing device to obtain information. This can lead to the reduction of manual data entry that needs to be performed by a user. By reducing the need for manual entry, inadvertent inputs and human error can be reduced. This can ultimately lead to more efficient use of computing resources such as memory usage, network usage, processing resources, etc.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1A illustrates a system used in an example scenario involving messages displayed within an original thread for an intra-message split initiated by analysis of a selected message.

FIG. 1B illustrates an example user interface displaying messages displayed in child threads generated from a split of an individual message of an original thread.

FIG. 2A illustrates a system used in an example scenario involving messages displayed within an original thread for an intra-message split initiated by an input.

FIG. 2B illustrates an example user interface displaying messages being moved by an input from an original thread to child threads.

FIG. 2C illustrates a user interface displaying messages that have been moved from an original thread to child threads.

FIG. 3A illustrates a system used in an example involving messages displayed within an original thread for an intra-message split initiated by an input during composition of a message.

FIG. 3B illustrates an example user interface displaying child threads with fields for accepting topics names.

FIG. 3C illustrates a first user interface displaying child threads with confirmed topics and a second user interface showing the original thread with the confirmed topics.

FIG. 3D illustrates an example user interface displaying child threads with confirmed topics during the composition of subsequent messages.

FIG. 3E illustrates an example user interface displaying child threads of a first user interface with confirmed topics after subsequent messages are sent and a second user interface with confirmed topics shown with a multi-topic thread.

FIG. 3F illustrates a first user interface displaying child threads split from a multi-topic thread and a second user interface showing the multi-topic thread during composition of a new message.

FIG. 3G illustrates a first user interface displaying child threads split from a multi-topic thread where one of the child threads shows a new message sent from a multi-topic thread, and a second user interface showing the multi-topic thread after the new message is sent.

FIG. 4A illustrates a system used in an example involving messages displayed within an original thread for an intra-message split initiated by an analysis of one or more select messages.

FIG. 4B illustrates a first user interface displaying child threads from an intra-message split of an original thread with computer-generated topics and a second user interface showing a multi-topic thread with the topics tagged in individual messages.

FIG. 4C illustrates a first user interface displaying child threads with computer-generated topics and a second user interface showing an input that can be used to invoke a split of a multi-topic thread.

FIG. 4D illustrates a first user interface displaying child threads with computer-generated topics and a second user interface showing child threads split from a multi-topic thread.

FIG. 5 shows a data structure that can be used to control user interface formats for individual users having split messages.

FIG. 6 is a flow diagram showing aspects of a routine for controlling message threads generated from intra-message divisions.

FIG. 7 is a computing system diagram showing aspects of an illustrative operating environment for the techniques disclosed herein.

FIG. 8 is a computing architecture diagram showing aspects of the configuration and operation of a computing device that can implement aspects of the techniques disclosed herein.

### DETAILED DESCRIPTION

The techniques disclosed herein provide a system for controlling message threads. In some configurations, a system can display messages from an original thread and activate a split of the original thread from within a single message. In response to a division of a single message, the system can group messages from the original thread into child threads each using customized topics. The disclosed techniques address a number of technical problems and provide a number of technical effects. In one example, by providing a display of messages that are organized in individual threads according to topics discovered within a single message, a computing device can effectively and more accurately display information in a format that can allow a granular level of control of how content is organized. This allows a system to display more accurate associations between messages and topics. In one illustrative example, by allowing a system to split a single message into different threads, the system can more accurately identify topics and sort messages that are appropriate for each topic. Without the ability to split a message that pertains to multiple topics, a system may have to duplicate that message for different threads. Also, a system that does not allow for a multi-topic message to be split creates a scenario where that message may be placed under a topic under one selected topic, which may not be entirely accurate for all portions of that message. In either case, this does not allow for a granular level of accuracy for systems that align individual messages with individual threads pertaining to particular topics. The techniques disclosed herein also provide a number of other technical benefits that can reduce redundant requests for information that is missed when messages are accurately not organized with topic threads. Among other technical effects, the improved user interactions disclosed herein lead to more efficient use of computing resources such as memory usage, network usage, processing resources.

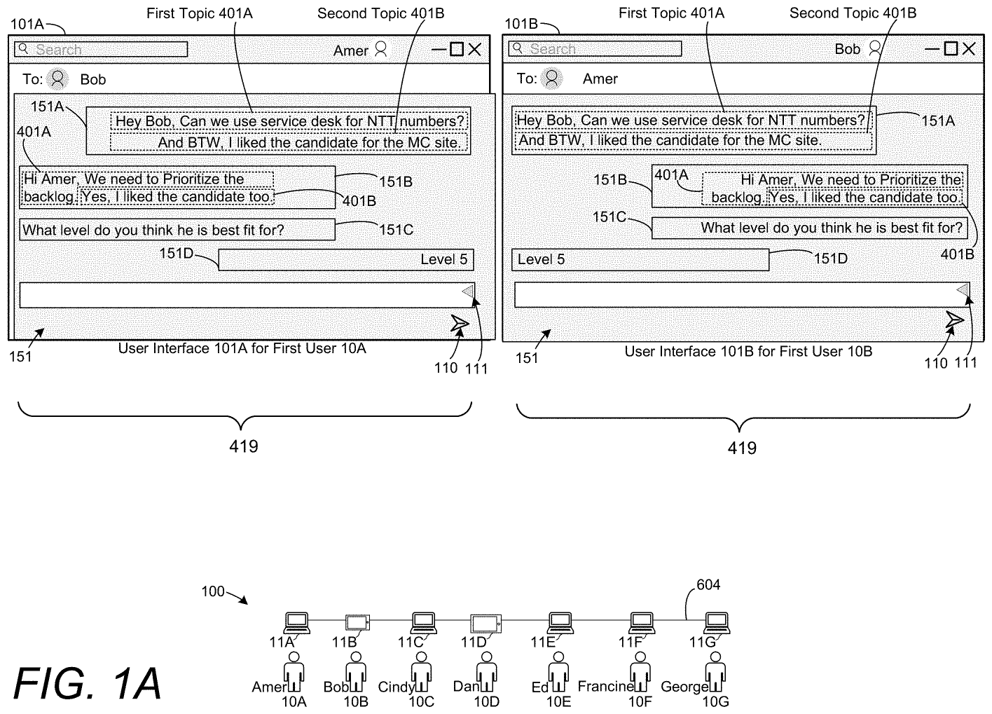

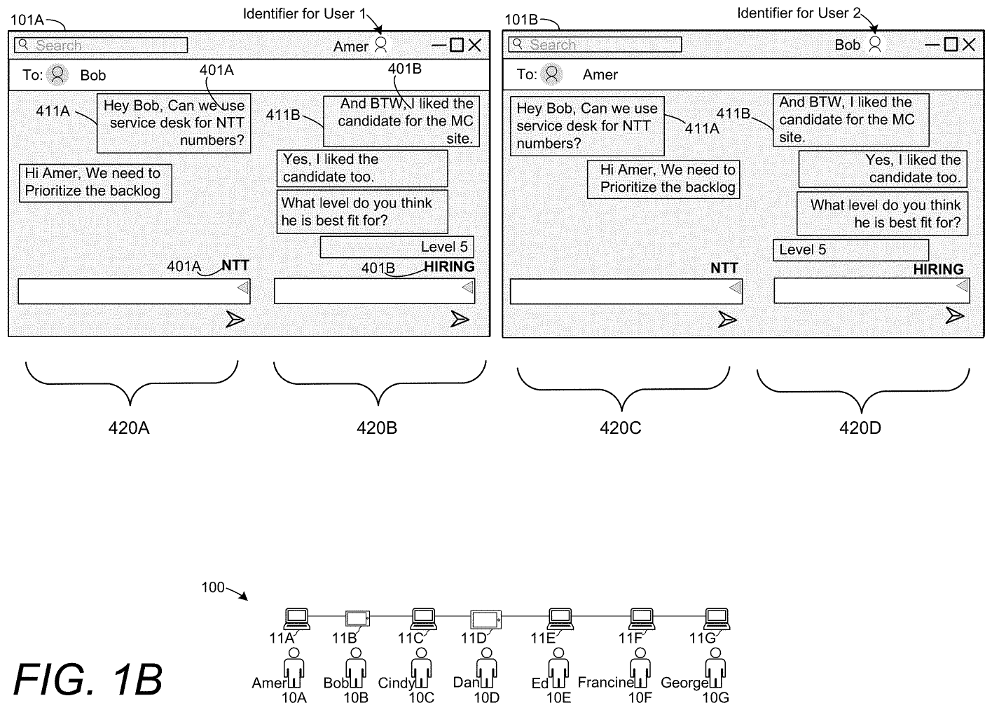

Referring now to FIG. 1A, aspects of a system 100 are shown and described below. In this example, individual computing devices 11 are interconnected with a communication session 604 configured for exchanging messages 151. Each user 10 is associated with a computing device 11 and each computing device 11 can display a user interface 101. In this example, a first user interface 101A is displayed on a screen of a first computing device 11A for a first user 10A. A second user interface 101B is displayed on a screen of a second computing device 11B for a second user 10B. Other users 10C-10G can also view similar user interfaces for those who are participating in a particular thread and have permission to view shared messages.

In the example of FIGS. 1A-1B, the first user 10A and the second user 10B are using their respective computers to send messages to one another. As shown in FIG. 1A, an original thread 419 comprises a set of messages 151. The system activates a split of the original thread 419 to generate two child threads 420 shown in FIG. 1B. The child threads 420 can include messages 411 having text content from a multi-topic message of the original thread 419, such the first message 151A. As shown, the first message 151A has text content pertaining to multiple topics 401, e.g., a first section of text pertaining to a first topic 401A, e.g., NTT numbers, and a second section of text pertaining to a second topic 401B, e.g., hiring.

In one of the initial stages of a process of splitting a message, the system can cause the first computer 11A to display a user interface 101A comprising an original thread 419 of a plurality of messages 151. A first message 151A from the original thread can include text content. In some configurations, the system can analyze the text content of a select message, such as the first message 151A, of the original thread 419 determine if the select message has multiple topics, e.g., identify at least a first topic 401A and a second topic 401B within the text content of the select message of the messages 151 of the original thread 419. For illustrative purposes, a first text portion of a select message, e.g., the first message 151A, of the original thread 119 is associated with the first topic 401A and a second text portion of the select message 151A is associated with the second topic 401B.

The analysis of the text to determine topics within a message can be based on any suitable technology. In some configurations, the analysis to determine the presence of multiple topics within a message can be based on the presence of predetermined words or predetermined word combinations that are in a single message. In some configurations, the analysis to determine topics within a message can also be based on the presence of word categories. In one illustrative example, predetermined nouns or verbs found within a message can be identified as a topic candidate. Predetermined words can also be categories of words like team names, product names, etc. Thus, any of the predetermined words, which may be retrieved from a database, can be used to identify topics within a message. Text in a predetermined format can also be selected as a topic candidate. For example, words in all cap characters or words in bold text may be selected as a topic candidate.

In some configurations, predetermined keywords that are found within a select message can be identified as a topic candidate. Keywords can be stored in a database and aligned with, or labeled as, a topic. The database can also maintain scores for each keyword and/or topic. When a keyword is identified in a message, a topic candidate can be selected. Topic candidates can also be selected using the other techniques disclosed herein. The topic candidates can be scored and ranked, and topic candidates having a threshold score, e.g., a threshold priority, can be selected as a topic for a child thread.

The system can also select text portions of a message and associate each portion with a particular topic. The text portions may be selected based on punctuation, text spacing, or the position of some text characters. In the example of FIG. 1A, based on the punctuation, the system can determine that there are two sentences. Each sentence can be analyzed to derive a topic candidate for each portion of text. For illustrative purposes, consider a scenario where the text is analyzed, and the system determines that the first sentence within the select message 151A pertains to a first topic 401A and a second sentence within the select message 151A pertains to a second topic 401B. In such an example, certain keywords, such as the subject of a phrase can be selected as a topic candidate, such as NTT, for the first topic 401A. In another example, a topic candidate can be selected from a list of topics that are associated with keywords. In such an example, the system can identify one or more keywords within a message, such as “candidate,” and automatically select a topic candidate, such as “hiring,” based on that keyword. If the topic candidate meets one or more criteria, such as a topic candidate having a priority threshold, that type of topic candidate can be selected as a topic for a new thread. This example is provided for illustrative purposes and is not to be construed as limiting. It can be appreciated that any suitable technology for identifying a topic within a collection of text can be utilized with the techniques disclosed herein.

If the system determines that two topic candidates of a single message are related, e.g., the topic candidates are the same or they are synonymous to a threshold degree, the system may determine that the associated message is a single-topic message. Such a determination can be made by scoring each topic candidate. For example, if a select message has a first portion, e.g., a first sentence, with the word “candidate” and another portion with the word “resume,” a first score can be associated with a word such as “candidate” and another score can be associated another word such as “resume.” These scores may indicate a threshold level of likeness given that they are both related to hiring. Thus, when a system detects a message having two portions with these two keywords having a threshold level of likeness, the system may not generate new child threads.

When a system detects a message having two portions with two keywords, and corresponding topic candidates that do not have a threshold level of likeness, the system may generate new child threads for each topic candidate. For example, a word in a first portion of a message, such as “NTT,” may be associated with a first score and another word in a second portion of the message, such as “candidate,” may be associated with a second score. These scores may not indicate a threshold level of likeness given that they are not related to a similar topic. Thus, a message having two portions with these two words that do not have a threshold level of likeness may be deemed as a multi-topic message. Once a single message is deemed to be a multi-topic message, the system can invoke one or more operations for splitting that message into two or more child threads as well as organizing other messages of the original thread into individual child threads.

In some embodiments, a system can also select one or more messages within the original thread 419 for analysis. Thus, the system may only analyze select messages meeting one or more criteria. By limiting the number of messages that are analyzed to detect multiple topics, a system may introduce further efficiencies with respect to computing resources. In one example, the system may only select messages having multiple sentences or multiple phrases. In such an example, any message having more than one sentence can be selected for analysis. In another example, the system may select messages that have more than a threshold number of words or characters. In such an example, only messages having more than a threshold number of words or threshold number of characters can be selected for analysis. In other examples, a system may select a message for analysis based on the position of the message within a user interface. This may include a position of a message within a thread or a viewing area, e.g., the last message of a thread or a message that is at the top of a viewing area, may only be selected for analysis. In yet another example, a system may select a message for analysis based on a timestamp or a state associated with the message. In such an example, a most recently received message may be selected for analysis, or a system may only select a message that is recently composed but not sent, etc. In other examples, a system may only select messages that have been received within a predetermined time period, or a system may only select message that have been received outside of a predetermined time period.

Other characteristics of a message, such as a format, can be used to select a message for analysis. This may include a font type, a threshold number of capital letters, threshold number of capital letters per word, or formatting combinations, e.g., a threshold number of characters in bold text, etc. Once a message is selected for analysis, the system determines if the message contains multiple topics. These examples are provided for illustrative purposes and are not to be construed as limiting. The system can utilize any property, condition, state or any combination of factors described herein to determine if a message is to be selected for analysis.

When the system determines that there are two or more topics discovered within a message, the system can initiate a split of the message and the original thread 419 to generate child threads and divide the text content of the message between the generated threads. In some configurations, responsive to the identification of multiple topics, e.g., the first topic and the second topic, within the text content of the original message 151A, the system can cause the user interface 101A shown in FIG. 1A to split the original thread 419 and the original message 151A and transition to an updated user interface shown in FIG. 1B. FIG. 1B shows an updated user interface 101A for the first user that shows a first child thread 420A and a second child thread 420B that is based on the split of the original thread 419. Similarly, a set of child threads, the third child thread 420C and the fourth child thread 420D, that are based on the split of the original thread 419 can be displayed on an updated user interface to a second user.

The updated user interface for each user can include a first message 411A positioned in a first new child thread 420A and a second message 411B positioned in a second new child thread 420B. The first message 411A can comprise the first text portion of the original message 151A that is associated with the first topic 401A, e.g., “Hey Bob, Can we use service desk for NTT numbers?” In addition, the second message 411B can include the second text portion of the original message 151A that is associated with the second topic 401B, e.g., “And BTW, I liked the candidate for the MC site.” Once the child threads are generated, the system can divide the remaining messages of the original thread into each child thread.

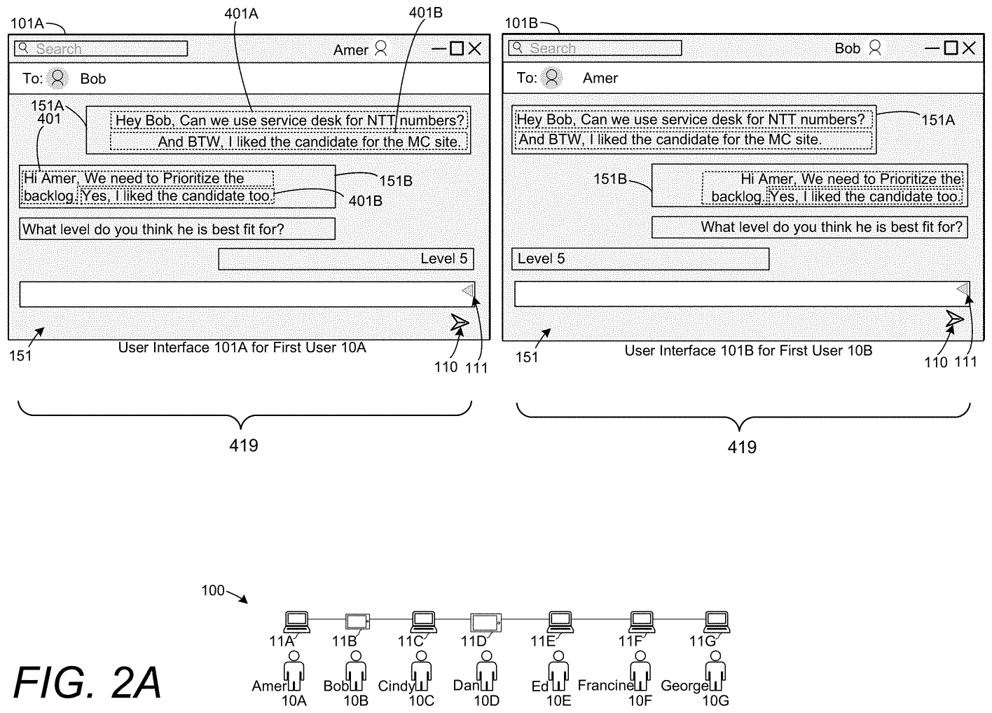

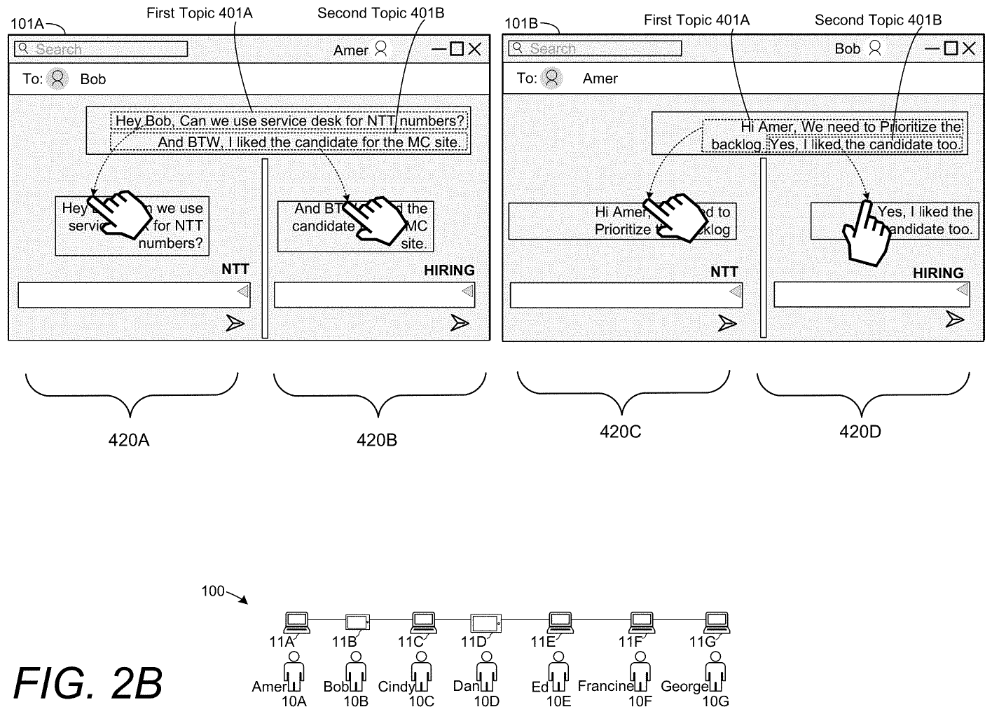

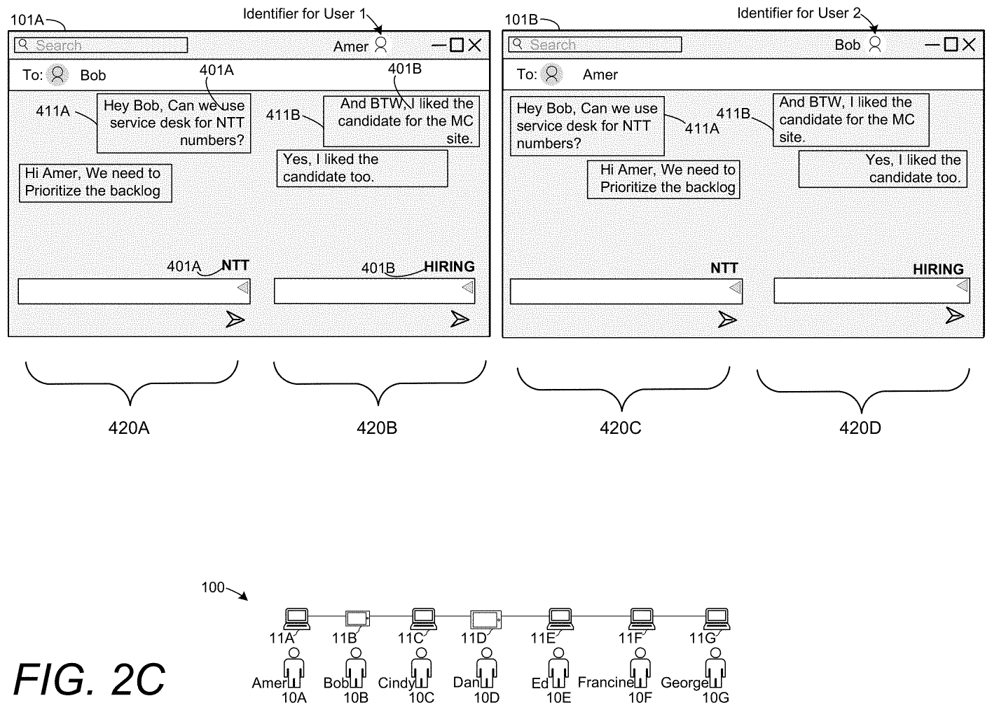

Now turning to FIG. 2A and FIG. 2B, an example scenario involving a message split that is invoked by a user input is shown and described below. Similar to FIG. 1A, the example of FIG. 2A shows a user interface 101A comprising an original thread 419 of a plurality of messages 151. A first message 151A from the original thread can include text content, which includes two portions. In this example, a similar user interface is displayed to the second user associated with the second computing device. Each user interface can also be configured with a split button 111 for invoking operations to split a thread. Each user interface can also be configured with a send button 110 for sending text in a text entry field to participants of a thread conversation.

In response to an input at the split button 111, the system can execute different operations to split a thread. In some configurations, the system can automatically analyze the contents of the message and invoke a split as described above. In other configurations, the system can configure a user interface to receive user inputs to associate messages or the original thread 419 with individual child threads 420. Although this example illustrates an input at a user interface, it can be appreciated that this input may be provided by other commands such as a voice command, a gesture captured by a camera, etc.

As shown in FIG. 2B, in response to the input causing the split, the system can generate updated user interfaces comprising a selected message 151A and a display of child threads 420 created by the split. The selected message is also referred to herein as an “anchoring message.” The message can be selected by a user input or by any of the other techniques disclosed herein. The topics listed in each thread can also be provided by a user input or generated by the computer as described above. In this example, one of the users, such as the first user 10A, can provide user input gestures that indicate a selection of a portion of the original message 151A. The user input can also indicate an association between the selected portion of the original message 151A and a select child thread. For instance, a user can perform a drag-and-drop gesture for the first sentence of the original message 151A, in which the first sentence is moved to the first child thread 420A. In this example, the user also performs a drag-and-drop gesture of the second sentence of the original message, in which the second sentence is moved to the second child thread 420B. Either user can perform the gesture input making the associations between each portion of the message and a child thread. In this example, the second user makes similar associations for portions of a second message 151B, where each portion is associated with the first and second topic respectively in the third thread 420C and the fourth thread 420D.

When one user makes the association between a portion of a message and a topic, that same association is made for the other user, as shown in FIG. 2C. As shown, the split of the first message 151A performed by the first user is recorded and displayed on the second computer 11B of the second user 11B. The split of the second message 151B performed by the second user is recorded and displayed on the first computer 11A of the first user 11A. The system can also record each user input for machine learning purposes. Thus, when a computer automatically makes associations between messages and topics, the associations between keywords and sentences can improve over time.

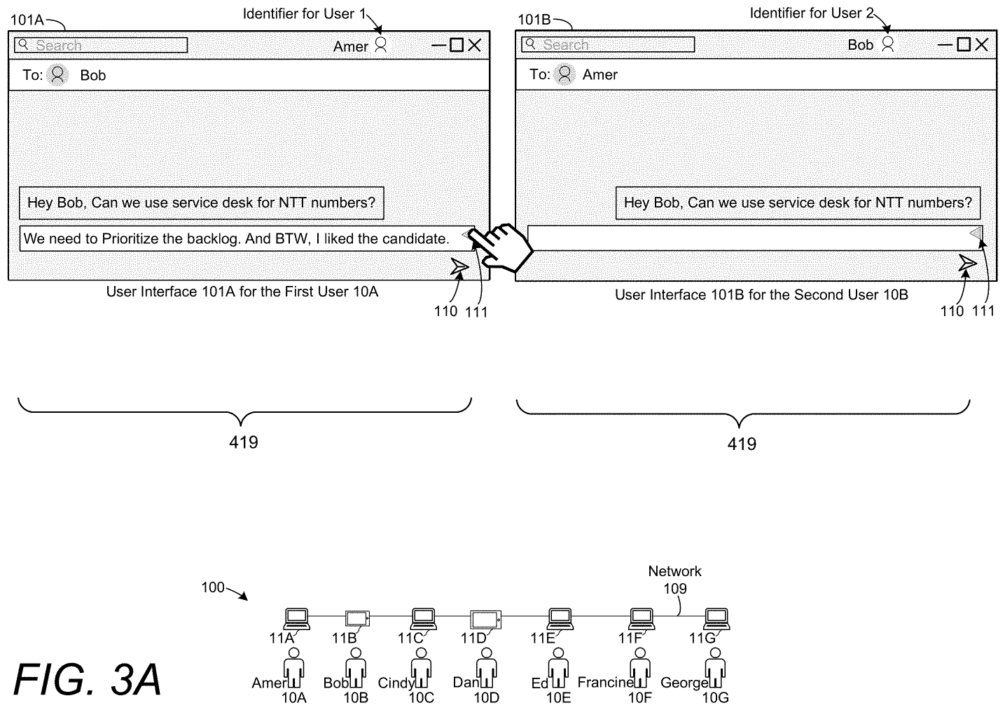

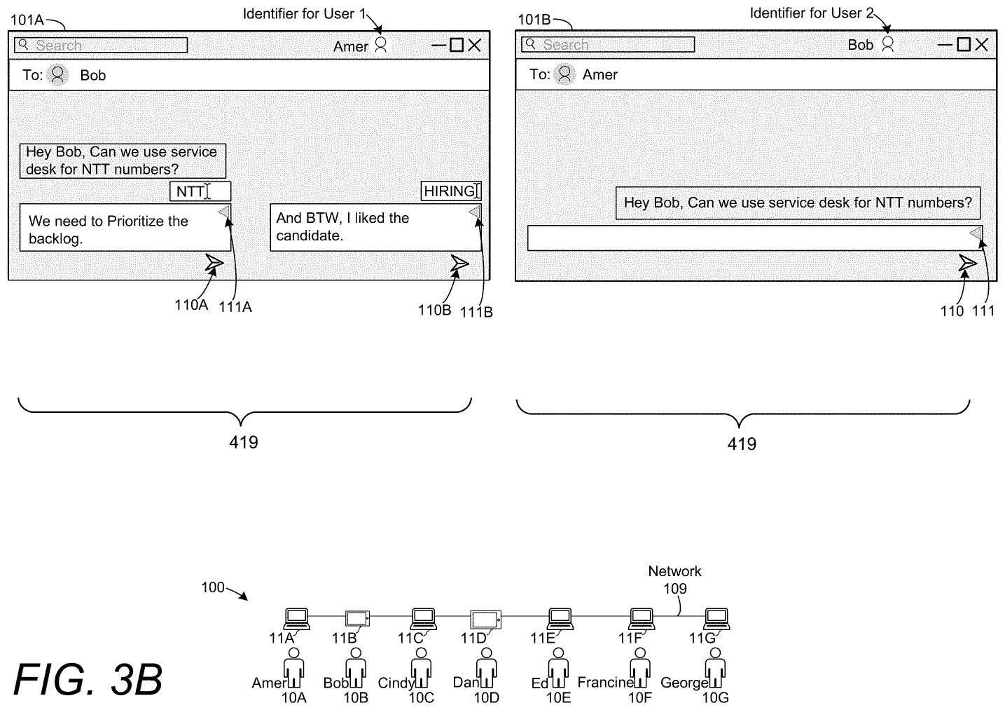

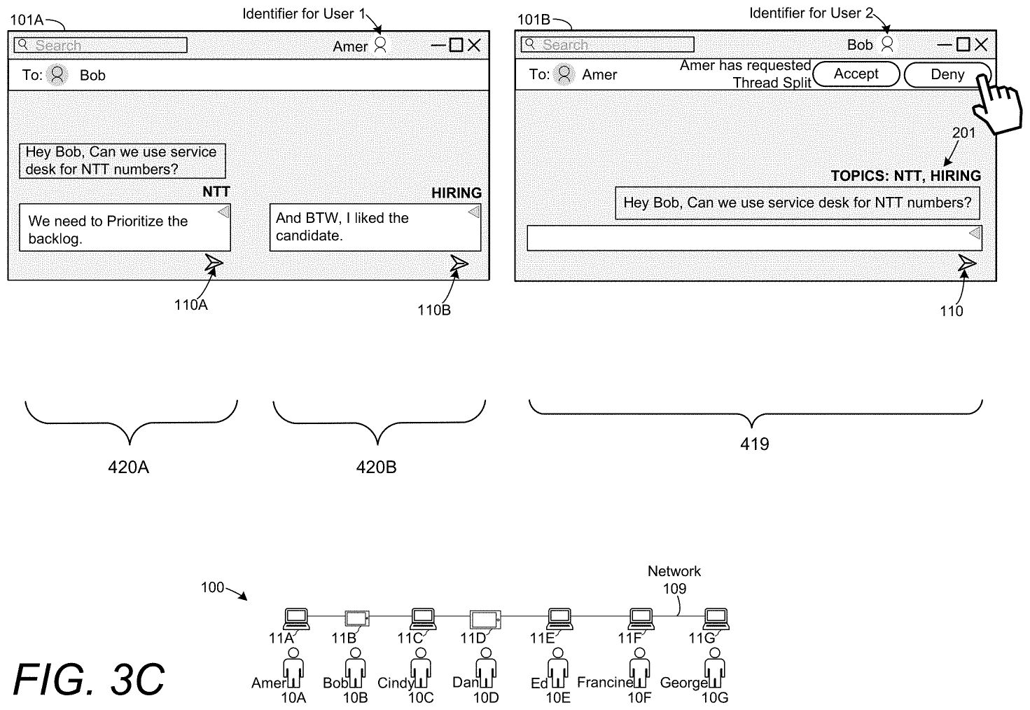

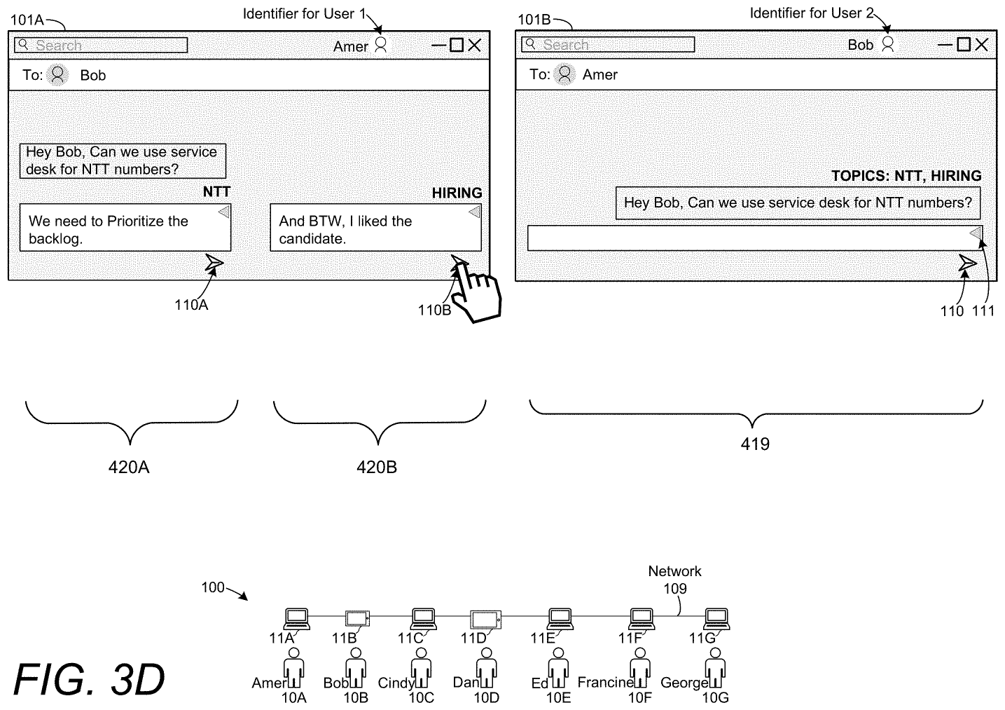

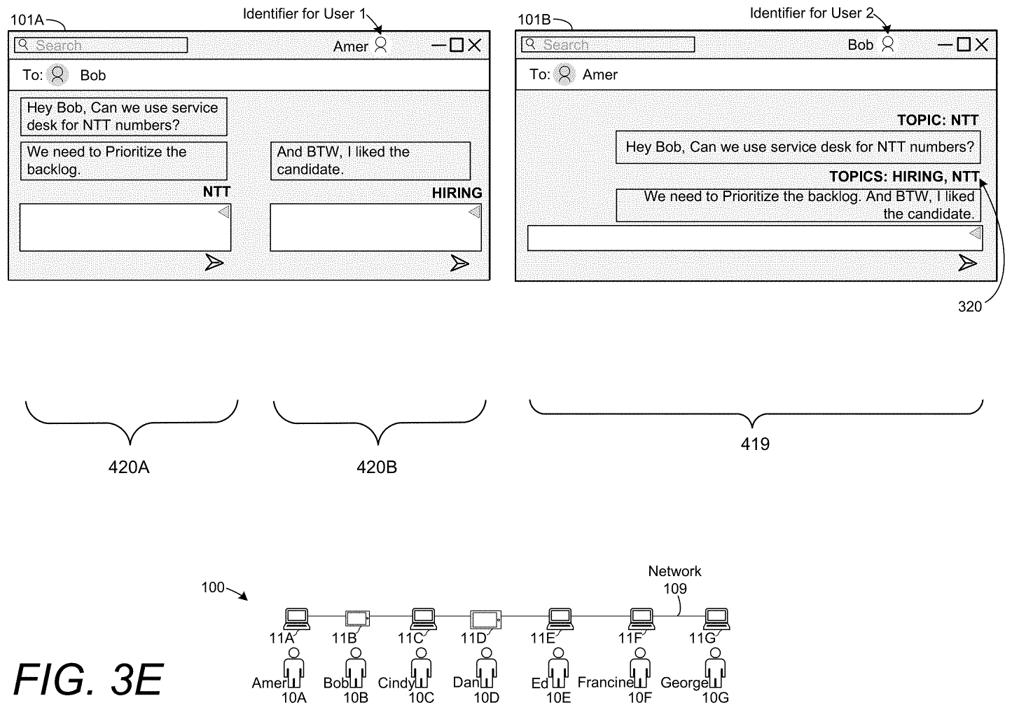

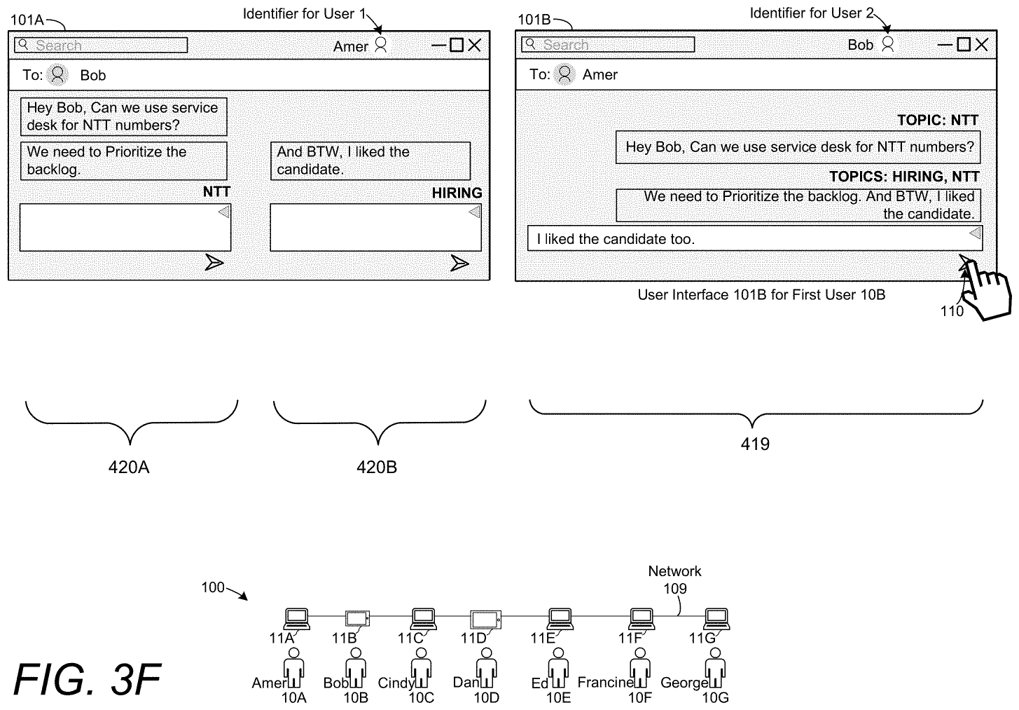

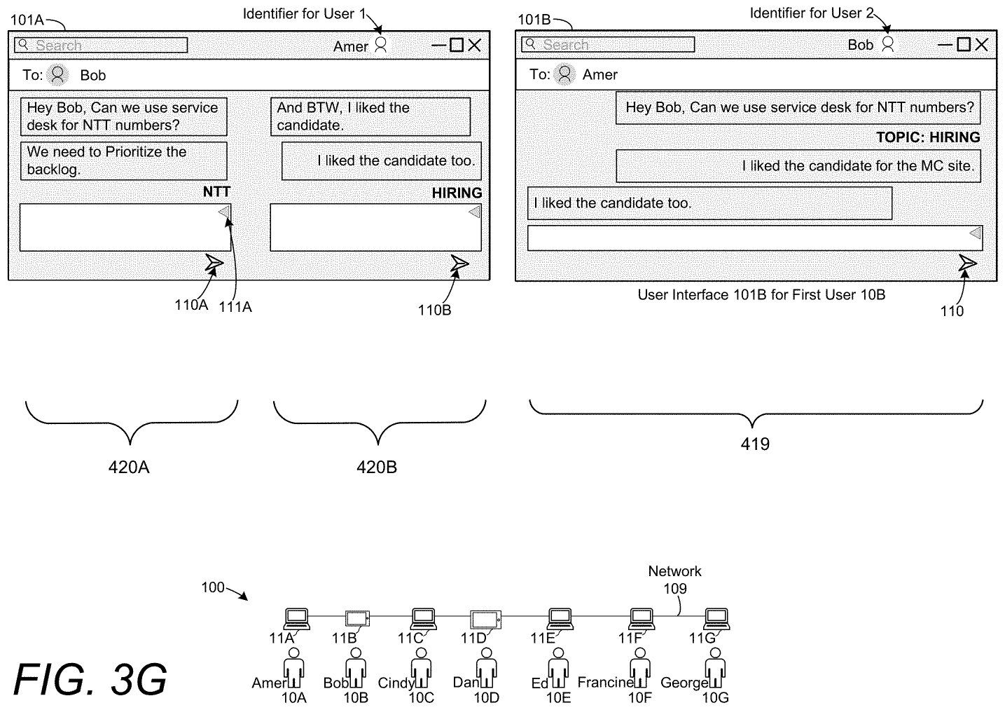

FIGS. 3A-3G show a number of variations to the process of performing an intra-message split. In one aspect, this example shows how a split can be performed during the composition of a message. In addition, this example illustrates an example of how users can deny the split request. In yet another aspect, this example illustrates how a user viewing a single multi-topic thread can send messages to a user viewing multiple single-topic threads.

FIG. 3A shows a scenario where a user starts to type a message and during that process, the user realizes that they are writing about two different topics. In that situation, the user can leave the typed message in a text entry field and invoke a message split. In this example, the user provides selection of a user interface element 111 configured to cause a message split. Also in this example, the user selects the split button 111 before they invoke the send button 110.

With reference to FIG. 3B, in response to receiving the input invoking the message split, the system generates an updated user interface with two child threads and displays text entry fields allowing the user to provide the topics for each thread. In this example, the user provides the names of topics for each child thread, e.g., NTT and HIRING. The system can also provide suggested topics in the text entry fields, where the suggested topics are topic candidates generated by the techniques disclosed herein. The first user can confirm the topics by the use of one or more inputs, e.g., the return character, a voice command, etc. Responsive to a confirmation of the topics, the system can split the message in the text entry field, e.g., the message being composed. This message may be split using techniques described herein, e.g., the message being composed can be selected for analysis when the user invokes the split control 111. The message can also be manually split using a drag-and-drop feature as described above. Once the topics are confirmed by the first user, the system may prompt the second user to allow the split. The second user can accept the split or deny the split. For illustrative purposes, as shown in FIG. 3C, the second user denies the split and the second user interface 101B remains as a single thread 419.

FIG. 3C shows the resulting user interface formats after the topics are confirmed by the first user and after the second user denies the split request. In this example, the user interface 101A for the first user comprises two child threads 420A and 420B that are generated from the original thread 419. The text entry fields for each child thread also comprise portions from the original text entry field from the original thread 119. The user interface 101B for the second user comprises the original thread 419. In this example, in response to the first user's request split the thread, and also in response to the second user's denial of that request, the system may provide a graphical element indicating split request was made. In this example, a graphical element 201 indicating the split is in the form of a text notification identifying the two topics provided by the first user. This notification provides notice to the second user of the topics selected by the first user. This notification also allows the second user to evaluate the proposed topics before accepting a thread split.

Turning now to FIG. 3D, once the child threads are generated for the first user, the messages being composed can be sent using one or more inputs, such as send buttons 110A and 110B. Once the messages are sent, as shown in the first user interface 101A of FIG. 3E, the system can move the messages from the text entry field of each thread to positions within the message thread. To facilitate this feature, the first computing device of the first user can associate each portion of the split message with a topic. For instance, since the first sentence “We need to Prioritize the backlog” is associated with the topic, NTT, and the first thread. The second sentence “And BTW, I liked the candidate” is associated with the second topic, HIRING, of the second thread. The first computer may communicate these associations to the second computer so the second computer can display any associated topics with any delivered message. In this example, for the second user interface 101B, the system can maintain the original thread and keep the message as originally composed as one message. At the same time, a second user interface element 320 can provide an indication of all of the topics related to that message.

FIGS. 3F and 3G show a process where a user viewing a single multi-topic thread communicates messages to a user with a split thread. In this example, the second user sends a message from the multi-topic thread shown in user interface 101B to the first user viewing multiple single-topic threads. FIG. 3F shows the second user typing the message “I liked the candidate too” and then pressing the send button 110. In response, as shown in FIG. 3G, the first user can receive the message in a thread that is most relevant to the content of the message. This feature can be achieved in a number of different ways. In one illustrative example, the system can analyze the sent message to determine its relevance with respect to all of the topics displayed to a recipient of the message. In this case, the recipient of the message has a user interface displaying two topics, NTT and HIRING. Based on a textual analysis of the sent message and the topics and the messages of each thread, the system may choose an appropriate topic and a corresponding thread for the received message. In this case, the message comprises the word “candidate,” which can be associated with the topic of “hiring.” This example is provided for illustrative purposes and is not to be construed as limiting. It can be appreciated that other techniques for selecting topics for an incoming message can be utilized with the techniques disclosed herein.

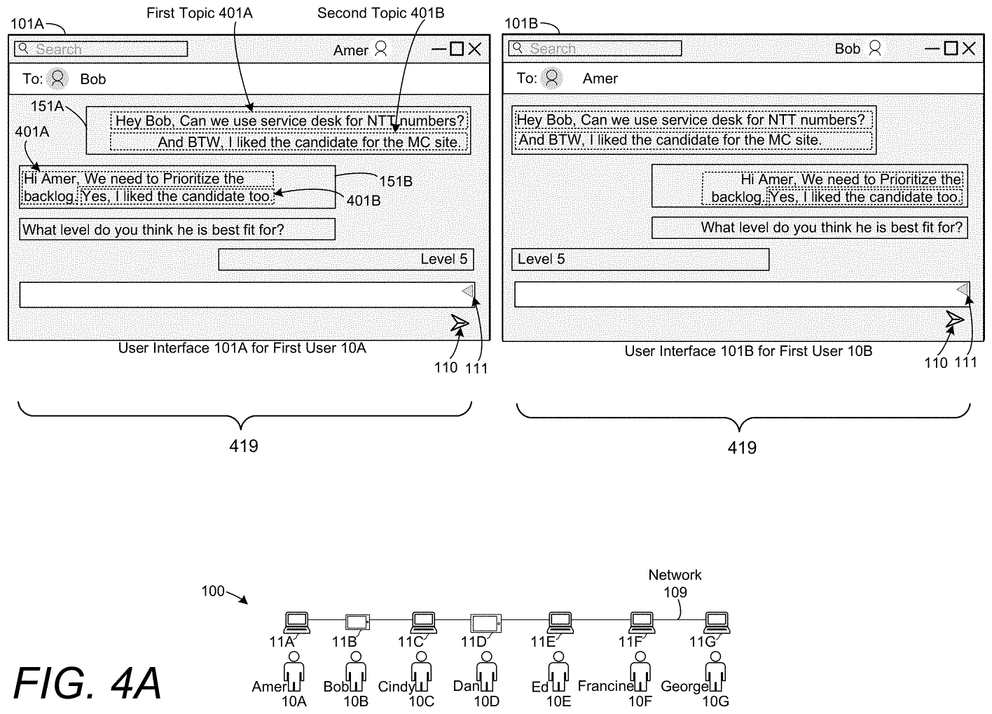

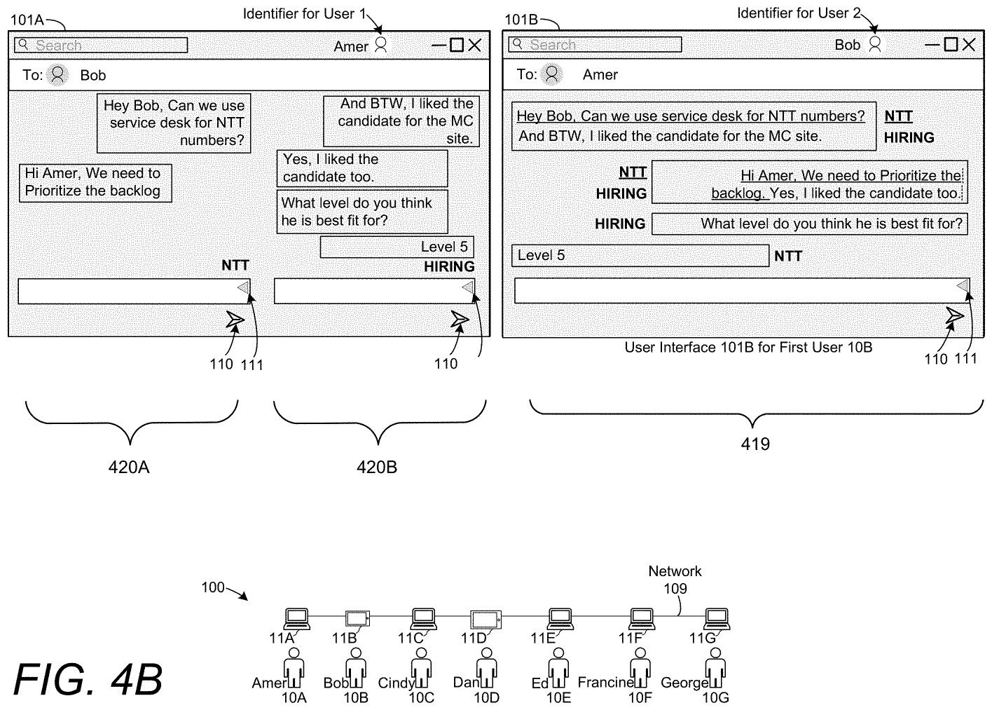

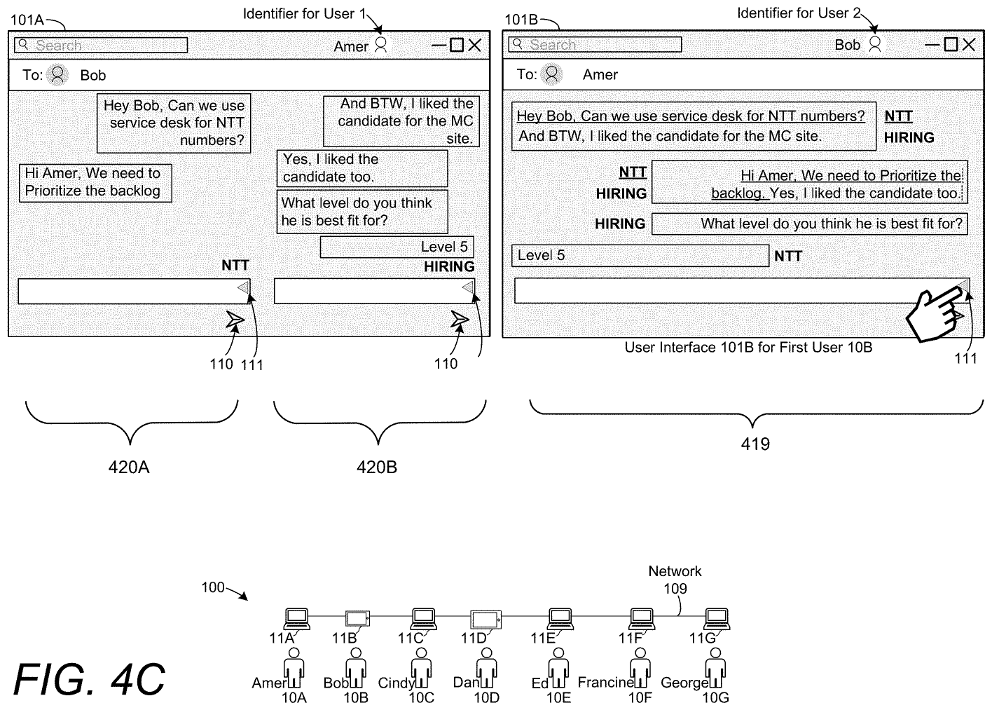

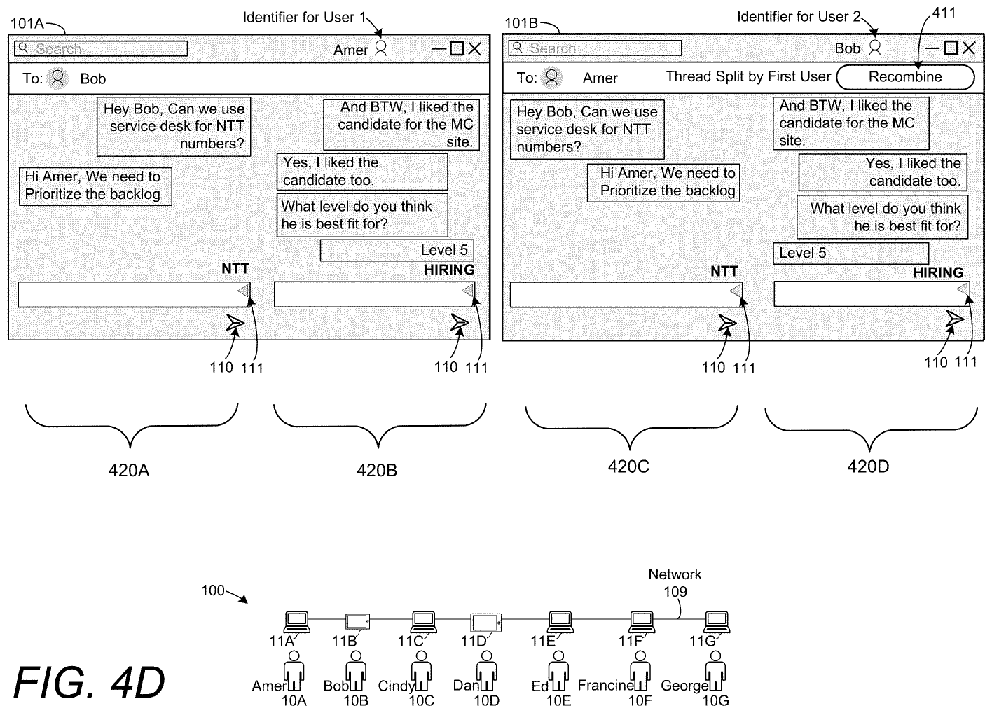

FIGS. 4A-4D show a number of other variations to the process of performing an intra-message split. In general, this example shows how a thread split can be requested by a first user and denied by a second user. In yet another aspect, this example illustrates how the second user can deny a split request front the first user, and then subsequently split the thread according to the first user's suggested topics. This example shows the flexibility of the techniques disclosed herein, which allow each user to independently toggle the user interface formats. The system is configured such that each user can toggle back and forth between a view of split threads having individual topics and a combined thread that has multiple topics.

FIG. 4A shows a user interface 101A comprising an original thread 419 of a plurality of messages 151. A first message 151A from the original thread can include text content, which includes two portions. In this example, a similar user interface is displayed to the second user associated with the second computing device. Each user interface can also be configured with a split button 111 for invoking operations to split a thread. Each user interface can also be configured with a send button 110 for sending text in a text entry field to participants of a thread conversation.

In response to an input at the split button 111, as shown in FIG. 4B, the system generates an updated user interface 101A for the first user, where the updated user interface 101A includes two child threads. The updated user interface 101A can display confirmed topics or display text entry fields allowing the user to provide the topics for each thread, as described above. Responsive to a confirmation of the topics, the system can split one or more select messages, including a message being composed. In this example, a first select message 151A and a second select message 151B are split using the techniques disclosed herein.

Also shown in FIG. 4B, the second user in this example has denied the split request, which can be done using the user interface 101B having the Accept and Deny input elements of FIG. 3C. Thus, in FIG. 4B, the second computer for the second user shows a single thread 419, with messages that are not split into topics. However, the topic labels are displayed for each topic to show the second user each topic for each message. This enables the second user to determine if a split should be initiated.

As shown in FIG. 4C, the second user actuates the split input element 111, which causes the second computing device to display the updated user interface shown in FIG. 4D. The updated user interface 101B for the second user includes two child threads 420C and 420D, which are child threads from the original thread 419. Also shown in FIG. 4D, the second user interface 101B can include a user interface element 405 configured to receive a user input and cause the UI to toggle back to the single, multi-topic thread shown in FIG. 4C. In response to a user input at the user interface element 405, the second computer can display the user interface format shown in FIG. 4C. Then when viewing the user interface format shown in FIG. 4C, the system can receive an input at the input element 111 to split the thread back to the user interface format shown in FIG. 4C.

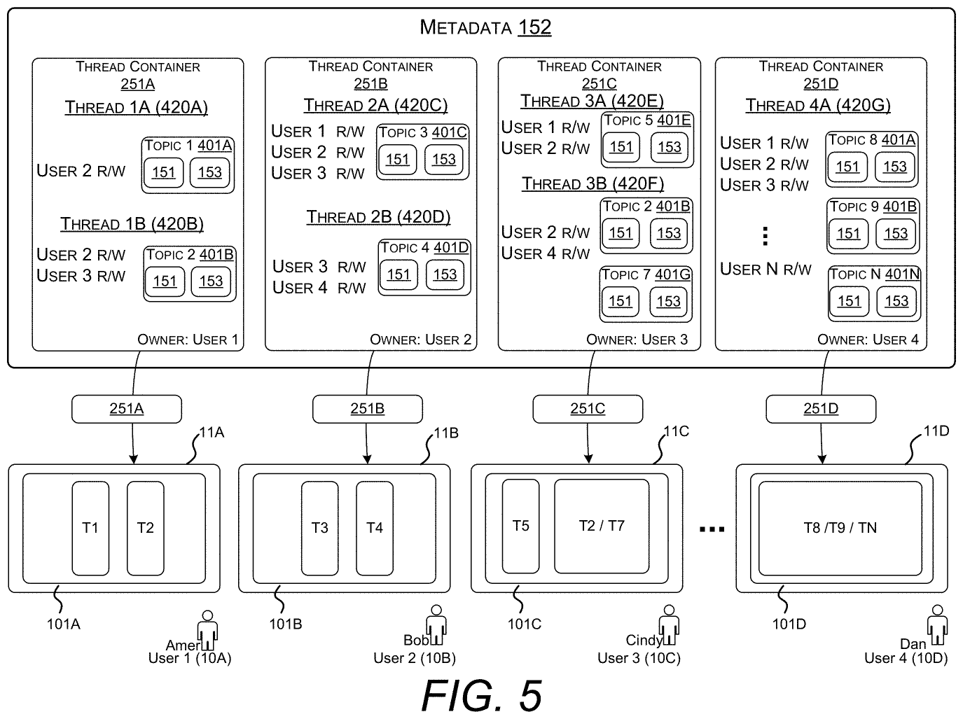

FIG. 5 illustrates a data structure 152 that can be utilized by a system to manage the states of the threads that are displayed each user. The data structure, also referred to herein as metadata 152, also comprises thread containers 251 for each user. The thread containers 251 can identify individual threads 420 configured by an individual user. The thread containers 251 can also associate individual topics 401 with individual threads 420 as well as associate individual messages 151 with each thread 420. In addition, the data structure shown in FIG. 5 can be utilized to manage user permissions for each thread. The system can keep track of individual permissions for each user on a per thread basis.

The data structure can be updated in response to the split of a message thread. For instance, an example of FIGS. 1A and 1B, in response to the split of the original thread 419, the system can generate individual records for each child thread and generate data storing the relationship between the original thread and the child thread. In addition, the child threads can inherit permissions from a parent thread. In this example, for the first user, the first child thread 420A has a first topic name and the second child thread 420B has a second topic name. In this example, the second user has permissions to read and write to each child thread. In addition, the first user has also added a third participant, User 310C, for the second child thread. Such an update can be performed by the first user since that user is a participant in that particular thread.

This example illustrates another feature of the present disclosure in that different users can have different topic labels for similar threads. A computing device, such as a server can also keep track of each user's thread settings and control the clients as updates are made to the data structure. For instance, with reference to the above example, when the first user or the first computer splits an original thread 419 and due to child threads, the first computer of the first user can send a split request to the second computer of the second user. The split request can indicate a topic name for each child topic, e.g., NTT and Hiring, as described above. The second user can accept that split request and the same topic names or the second user can deny that split request and keep one thread. Alternatively, the second user can accept the split request and rename each child thread different topic names. In such a scenario, one or more computers of the system can update the data structure 152 to record any topic names the second user has provided. In this case, the second user shows a third topic for the third thread 420C and a fourth topic for the fourth thread 420D, which are different from the topics selected by the first user.

Also shown in FIG. 5, users can also have different thread configurations where they can have a single-topic thread for select topics while also having multi-topic threads for other lower priority topics. For example, a third device of the third user 10C has configured two threads within a user interface where the first thread 420E comprises a single topic 401E with messages that can be accessed by the first and second user. At the same time, the interface of the third user also comprises a thread 420F that pertains to two different topics, the second 401B and a seventh topic 401G. In yet another example, a fourth computing device of the fourth user 10D has configured a user interface to have a single multi-topic thread having three topics and up to N numbers of users accessing the messages of that multi-topic thread.

Also shown in FIG. 5, the data structure also includes priority data 153 associated with each topic. The priority data can indicate a priority for each topic and/or a topic threshold score. This allows the system to determine if a user wants to split a thread based on the identification of a particular topic. For instance, with respect to the examples described herein, a first user or a first computer may split an original thread into two child threads based on the identification of two topics within a single message or within several messages. In response to the identification of the two topics, the first computing device may split the original thread into multiple threads, one thread for each topic. The first computing device may then send a split request to other devices where the split request identifies the topic names. The devices receiving the split request may then determine if a split is to be made based on a score or a topic threshold score associated with the identified topics. If a score or a topic threshold score meets one or more criteria, the device receiving the split request may split an original thread. Alternatively, if the topic threshold score or the score does not meet one or more criteria, the device may deny the split request and maintain the display of an original thread.

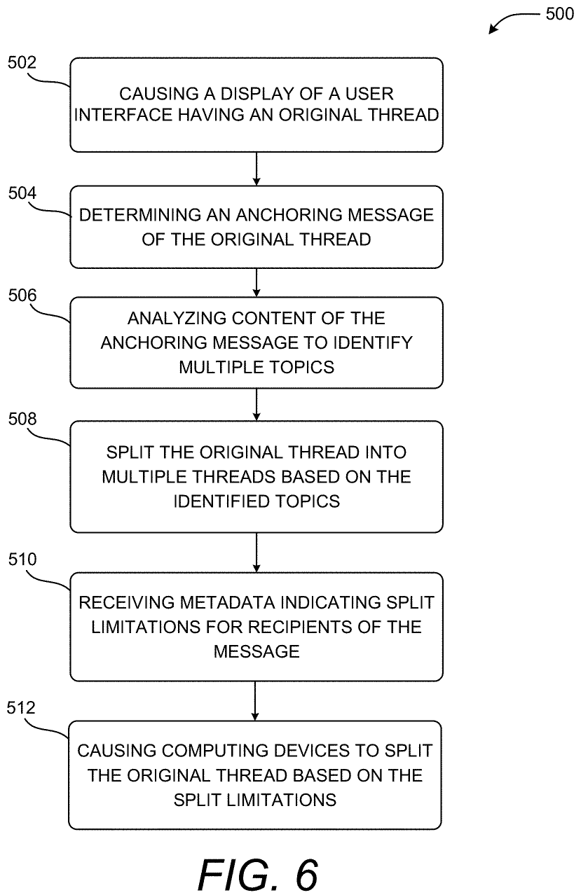

FIG. 6 is a diagram illustrating aspects of a routine 500 for enabling users to split message threads into child message threads. It should be understood by those of ordinary skill in the art that the operations of the methods disclosed herein are not necessarily presented in any particular order and that performance of some or all of the operations in an alternative order is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entirety. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Although the example routine described below is operating on a system, e.g., one or more computing devices, it can be appreciated that this routine can be performed on any computing system which may include any number of computers working in concert to perform the operations disclosed herein.

Thus, it should be appreciated that the logical operations described herein are implemented as a sequence of computer implemented acts or program modules running on a computing system such as those described herein and/or as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

Additionally, the operations illustrated in FIG. 6 and the other FIGURES can be implemented in association with the example presentation user interfaces UI described above. For instance, the various devices and/or modules described herein can generate, transmit, receive, and/or display data associated with content of a communication session e.g., live content, broadcasted event, recorded content, etc. and/or a presentation UI that includes renderings of one or more participants of remote computing devices, avatars, channels, chat sessions, video streams, images, virtual objects, and/or applications associated with a communication session.

The routine 500 includes an operation 502 where the system causes one or more computing devices to display a user interface 101A comprising an original thread 419 of a plurality of messages 151. The user interface can include an original message 151A of the plurality of messages 151 comprises text content. An example of the original thread 419 is shown in FIG. 1A.

Next, at operation 504, the system can select an anchoring message from the original thread. The anchoring message, also referred to herein as the “selected message,” can be a message that is analyzed to detect the presence of multiple topics within a single message. As described herein, the anchoring message can be selected based on a number of factors, including, a location of the message within a user interface, a location of the message within a thread, a timestamp associated with the message, a drafting status of a message, punctuation or formatting of the message, or any other characteristic or attribute of a message. For instance, a recently received or a recently sent message can be selected for analysis. In other embodiments, the selected message may include a message being composed by user. The techniques disclosed herein can also select a range of different messages for analysis. For instance, messages containing multiple sentences, or a predetermined number of characters or words can be selected for analysis.

Next, at operation 506, the system can cause an analysis of the selected message, e.g., the anchoring message. In some configurations, the system can analyze the text content of the selected message, such as a first message or a most recent message. In the example of FIG. 1A, a first message 151A is selected and analyzed to identify a first topic 401A and a second topic 401B within the text content of the original message 151A of the plurality of messages 105. A first text portion of the original message 151A is associated with the first topic 401A and a second text portion of the original message 151A is associated with the second topic 401B.

Next, at operation 508, the system can cause a split of the select message and cause the original thread to be split into multiple child threads. Operation 508 can be executed in response to a number of actions, the identification of multiple topics within a message, a user input dictating a message split, or other activities described herein. In some configurations, responsive to the identification of the first topic and the second topic within the text content of the original message 151A, e.g., multiple topics in a message, the system can cause the first user interface 101A to split the original thread 419 and the original message 151A by displaying a first message 411 positioned in a first new thread 420A and a second message 412 positioned in a second new thread 420B, wherein the first message 411 comprises the first text portion of the original message 151A that is associated with the first topic 401A, and wherein the second message 412 comprises the second text portion of the original message 151A that is associated with the second topic 401B.

In some configurations, the split of the original thread is only performed in response to determining that the first topic or the second topic have associated scores that exceed a threshold priority score. The threshold priority score may be different for each user and stored in the metadata. Thus, the topics of NTT and Hiring may cause a spilt for a first user but not cause a split for a second user that has a higher threshold priority score for such topics versus the first user. Thus, a second computer, such as the examples shown herein, may deny a split request based on a user input or based on priority thresholds for each topic and/or each user.

Next, at operation 510, the system can receive metadata indicating a split limitation. In one illustrative example, a first user can initiate a split of a thread displayed on a first computer by an input. Split of the thread displayed on the first computer can cause the generation of a split request to a second computing device. In response to the split request, the second computing device can determine if the split request is to be denied or accepted. If the split is accepted, then the routine 500 proceeds to operation 512 where the second computing device original thread into multiple child threads.

In another scenario, in response to the split request, the second computing device can determine that a split is denied. In such an operation, the second computer may send metadata indicating a split limitation to a server where the server updates a data structure indicating that the second computing device has denied a split. In some configurations, the split limitation to be in the form of a maximum number of splits for a particular computing device. Thus, a device may accept a number of thread splits up to a maximum number of thread splits for that particular device. Once the maximum number of thread splits has been reached for a particular device, that device may decline any subsequent split requests received from other computers. Such limitations can be communicated to a server or other to update stored metadata used for coordinating the display of threads between computing devices.

The techniques disclosed herein also provide a number of machine learning techniques where user inputs and other determinations can be used to update model that can be relied upon in future iterations of the routine. For instance, if a computing device determines that a particular message is to be associated with a topic and thus a particular thread, a machine learning model may record the association between the message and the topic. However, at a later time, if a user input provides a correction to that association, that correction can be recorded within a machine learning model to improve future associations between aspects of that particular message and one or more topics. For instance, with respect to the example of FIG. 1A, if the system initially associates the message “level 5” with the second topic, that association recorded within machine learning model. However, if the user moves that message to another topic such as “NTT,” that new association can be used to update the machine learning model to associate keywords like “Level” with the NTT topic.

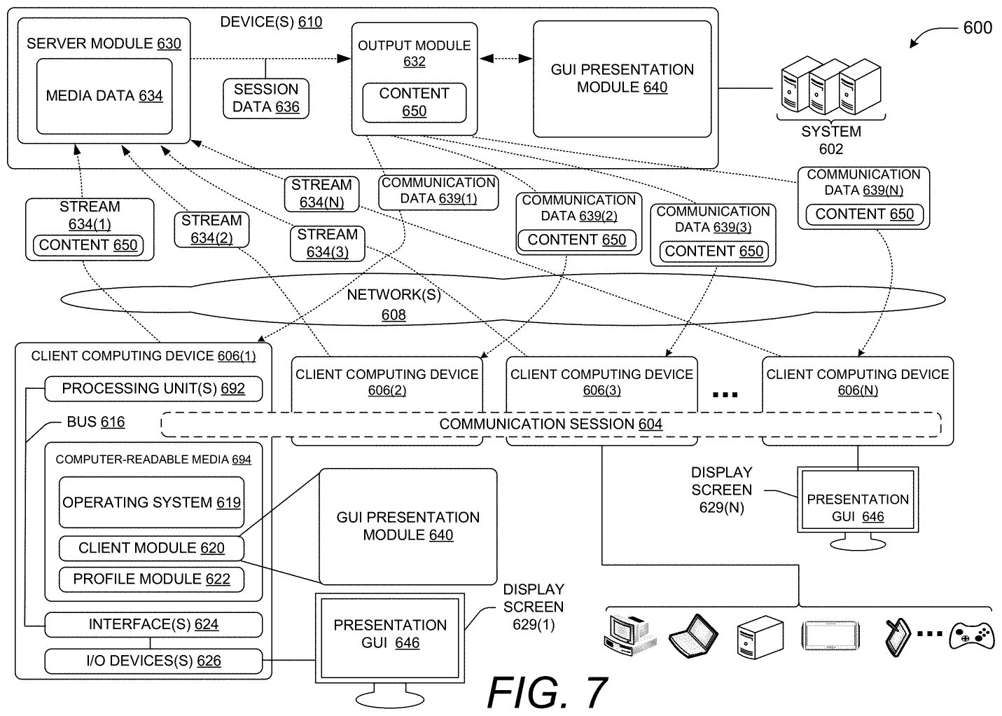

FIG. 7 is a diagram illustrating an example environment 600 in which a system 602 can implement the techniques disclosed herein. It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as field-programmable gate arrays (“FPGAs”), digital signal processors (“DSPs”), or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

In some implementations, a system 602 may function to collect, analyze, and share data that is displayed to users of a communication session 604. As illustrated, the communication session 603 may be implemented between a number of client computing devices 606(1) through 606(N) (where N is a number having a value of two or greater) that are associated with or are part of the system 602. The client computing devices 606(1) through 606(N) enable users, also referred to as individuals, to participate in the communication session 603.

In this example, the communication session 603 is hosted, over one or more network(s) 608, by the system 602. That is, the system 602 can provide a service that enables users of the client computing devices 606(1) through 606(N) to participate in the communication session 603 (e.g., via a live viewing and/or a recorded viewing). Consequently, a “participant” to the communication session 603 can comprise a user and/or a client computing device (e.g., multiple users may be in a room participating in a communication session via the use of a single client computing device), each of which can communicate with other participants. As an alternative, the communication session 603 can be hosted by one of the client computing devices 606(1) through 606(N) utilizing peer-to-peer technologies. The system 602 can also host chat conversations and other team collaboration functionality (e.g., as part of an application suite).

In some implementations, such chat conversations and other team collaboration functionality are considered external communication sessions distinct from the communication session 603. A computing system 602 that collects participant data in the communication session 603 may be able to link to such external communication sessions. Therefore, the system may receive information, such as date, time, session particulars, and the like, that enables connectivity to such external communication sessions. In one example, a chat conversation can be conducted in accordance with the communication session 603. Additionally, the system 602 may host the communication session 603, which includes at least a plurality of participants co-located at a meeting location, such as a meeting room or auditorium, or located in disparate locations.

In examples described herein, client computing devices 606(1) through 606(N) participating in the communication session 603 are configured to receive and render for display, on a user interface of a display screen, communication data. The communication data can comprise a collection of various instances, or streams, of live content and/or recorded content. The collection of various instances, or streams, of live content and/or recorded content may be provided by one or more cameras, such as video cameras. For example, an individual stream of live or recorded content can comprise media data associated with a video feed provided by a video camera (e.g., audio and visual data that capture the appearance and speech of a user participating in the communication session). In some implementations, the video feeds may comprise such audio and visual data, one or more still images, and/or one or more avatars. The one or more still images may also comprise one or more avatars.

Another example of an individual stream of live or recorded content can comprise media data that includes an avatar of a user participating in the communication session along with audio data that captures the speech of the user. Yet another example of an individual stream of live or recorded content can comprise media data that includes a file displayed on a display screen along with audio data that captures the speech of a user. Accordingly, the various streams of live or recorded content within the communication data enable a remote meeting to be facilitated between a group of people and the sharing of content within the group of people. In some implementations, the various streams of live or recorded content within the communication data may originate from a plurality of co-located video cameras, positioned in a space, such as a room, to record or stream live a presentation that includes one or more individuals presenting and one or more individuals consuming presented content.

A participant or attendee can view content of the communication session 603 live as activity occurs, or alternatively, via a recording at a later time after the activity occurs. In the examples described herein, client computing devices 606(1) through 606(N) participating in the communication session 603 are configured to receive and render for display, on a user interface of a display screen, communication data. The communication data can comprise a collection of various instances, or streams, of live and/or recorded content. For example, an individual stream of content can comprise media data associated with a video feed (e.g., audio and visual data that capture the appearance and speech of a user participating in the communication session). Another example of an individual stream of content can comprise media data that includes an avatar of a user participating in the conference session along with audio data that captures the speech of the user. Yet another example of an individual stream of content can comprise media data that includes a content item displayed on a display screen and/or audio data that captures the speech of a user. Accordingly, the various streams of content within the communication data enable a meeting or a broadcast presentation to be facilitated amongst a group of people dispersed across remote locations.

A participant or attendee to a communication session is a person that is in range of a camera, or other image and/or audio capture device such that actions and/or sounds of the person which are produced while the person is viewing and/or listening to the content being shared via the communication session can be captured (e.g., recorded). For instance, a participant may be sitting in a crowd viewing the shared content live at a broadcast location where a stage presentation occurs. Or a participant may be sitting in an office conference room viewing the shared content of a communication session with other colleagues via a display screen. Even further, a participant may be sitting or standing in front of a personal device (e.g., tablet, smartphone, computer, etc.) viewing the shared content of a communication session alone in their office or at home.

The system 602 of FIG. 7 includes device(s) 610. The device(s) 610 and/or other components of the system 602 can include distributed computing resources that communicate with one another and/or with the client computing devices 606(1) through 606(N) via the one or more network(s) 608. In some examples, the system 602 may be an independent system that is tasked with managing aspects of one or more communication sessions such as communication session 603. As an example, the system 602 may be managed by entities such as SLACK, WEBEX, GOTOMEETING, GOOGLE HANGOUTS, etc.

Network(s) 608 may include, for example, public networks such as the Internet, private networks such as an institutional and/or personal intranet, or some combination of private and public networks. Network(s) 608 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 608 may utilize communications protocols, including packet-based and/or datagram-based protocols such as Internet protocol (“IP”), transmission control protocol (“TCP”), user datagram protocol (“UDP”), or other types of protocols. Moreover, network(s) 608 may also include a number of devices that facilitate network communications and/or form a hardware basis for the networks, such as switches, routers, gateways, access points, firewalls, base stations, repeaters, backbone devices, and the like.

In some examples, network(s) 608 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, 802.11ac and so forth), and other standards.

In various examples, device(s) 610 may include one or more computing devices that operate in a cluster or other grouped configuration to share resources, balance load, increase performance, provide fail-over support or redundancy, or for other purposes. For instance, device(s) 610 may belong to a variety of classes of devices such as traditional server-type devices, desktop computer-type devices, and/or mobile-type devices. Thus, although illustrated as a single type of device or a server-type device, device(s) 610 may include a diverse variety of device types and are not limited to a particular type of device. Device(s) 610 may represent, but are not limited to, server computers, desktop computers, web-server computers, personal computers, mobile computers, laptop computers, tablet computers, or any other sort of computing device.

A client computing device (e.g., one of client computing device(s) 606(1) through 606(N)) (each of which are also referred to herein as a “data processing system”) may belong to a variety of classes of devices, which may be the same as, or different from, device(s) 610, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (“AR”) device, an implanted computing device, an automotive computer, a network-enabled television, a thin client, a terminal, an Internet of Things (“IoT”) device, a work station, a media player, a personal video recorder (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 606(1) through 606(N) of the various classes and device types can represent any type of computing device having one or more data processing unit(s) 692 operably connected to computer-readable media 694 such as via a bus 616, which in some instances can include one or more of a system bus, a data bus, an address bus, a PCI bus, a Mini-PCI bus, and any variety of local, peripheral, and/or independent buses.

Executable instructions stored on computer-readable media 694 may include, for example, an operating system 619, a client module 620, a profile module 622, and other modules, programs, or applications that are loadable and executable by data processing units(s) 692.

Client computing device(s) 606(1) through 606(N) may also include one or more interface(s) 624 to enable communications between client computing device(s) 606(1) through 606(N) and other networked devices, such as device(s) 610, over network(s) 608. Such network interface(s) 624 may include one or more network interface controllers (NICs) or other types of transceiver devices to send and receive communications and/or data over a network. Moreover, client computing device(s) 606(1) through 606(N) can include input/output (“I/O”) interfaces (devices) 626 that enable communications with input/output devices such as user input devices including peripheral input devices (e.g., a game controller, a keyboard, a mouse, a pen, a voice input device such as a microphone, a video camera for obtaining and providing video feeds and/or still images, a touch input device, a gestural input device, and the like) and/or output devices including peripheral output devices (e.g., a display, a printer, audio speakers, a haptic output device, and the like). FIG. 7 illustrates that client computing device 606(1) is in some way connected to a display device (e.g., a display screen 629(N)), which can display a UI according to the techniques described herein.

In the example environment 600 of FIG. 7, client computing devices 606(1) through 606(N) may use their respective client modules 620 to connect with one another and/or other external device(s) in order to participate in the communication session 603, or in order to contribute activity to a collaboration environment. For instance, a first user may utilize a client computing device 606(1) to communicate with a second user of another client computing device 606(2). When executing client modules 620, the users may share data, which may cause the client computing device 606(1) to connect to the system 602 and/or the other client computing devices 606(2) through 606(N) over the network(s) 608.

The client computing device(s) 606(1) through 606(N) may use their respective profile modules 622 to generate participant profiles (not shown in FIG. 7) and provide the participant profiles to other client computing devices and/or to the device(s) 610 of the system 602. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for communication sessions.

As shown in FIG. 7, the device(s) 610 of the system 602 include a server module 630 and an output module 632. In this example, the server module 630 is configured to receive, from individual client computing devices such as client computing devices 606(1) through 606(N), media streams 634(1) through 634(N). As described above, media streams can comprise a video feed (e.g., audio and visual data associated with a user), audio data which is to be output with a presentation of an avatar of a user (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 630 is configured to receive a collection of various media streams 634(1) through 634(N) during a live viewing of the communication session 603 (the collection being referred to herein as “media data 634”). In some scenarios, not all of the client computing devices that participate in the communication session 603 provide a media stream. For example, a client computing device may only be a consuming, or a “listening”, device such that it only receives content associated with the communication session 603 but does not provide any content to the communication session 603.

In various examples, the server module 630 can select aspects of the media streams 634 that are to be shared with individual ones of the participating client computing devices 606(1) through 606(N). Consequently, the server module 630 may be configured to generate session data 636 based on the streams 634 and/or pass the session data 636 to the output module 632. Then, the output module 632 may communicate communication data 639 to the client computing devices (e.g., client computing devices 606(1) through 606(3) participating in a live viewing of the communication session). The communication data 639 may include video, audio, and/or other content data, provided by the output module 632 based on content 650 associated with the output module 632 and based on received session data 636. The content 650 can include the streams 634 or other shared data, such as an image file, a spreadsheet file, a slide deck, a document, etc. The streams 634 can include a video component depicting images captured by an I/O device 626 on each client computer.

As shown, the output module 632 transmits communication data 639(1) to client computing device 606(1), and transmits communication data 639(2) to client computing device 606(2), and transmits communication data 639(3) to client computing device 606(3), etc. The communication data 639 transmitted to the client computing devices can be the same or can be different (e.g., positioning of streams of content within a user interface may vary from one device to the next).

In various implementations, the device(s) 610 and/or the client module 620 can include GUI presentation module 640. The GUI presentation module 640 may be configured to analyze communication data 639 that is for delivery to one or more of the client computing devices 606. Specifically, the UI presentation module 640, at the device(s) 610 and/or the client computing device 606, may analyze communication data 639 to determine an appropriate manner for displaying video, image, and/or content on the display screen 629 of an associated client computing device 606. In some implementations, the GUI presentation module 640 may provide video, image, and/or content to a presentation GUI 646 rendered on the display screen 629 of the associated client computing device 606. The presentation GUI 646 may be caused to be rendered on the display screen 629 by the GUI presentation module 640. The presentation GUI 646 may include the video, image, and/or content analyzed by the GUI presentation module 640.

In some implementations, the presentation GUI 646 may include a plurality of sections or grids that may render or comprise video, image, and/or content for display on the display screen 629. For example, a first section of the presentation GUI 646 may include a video feed of a presenter or individual, a second section of the presentation GUI 646 may include a video feed of an individual consuming meeting information provided by the presenter or individual. The GUI presentation module 640 may populate the first and second sections of the presentation GUI 646 in a manner that properly imitates an environment experience that the presenter and the individual may be sharing.

In some implementations, the GUI presentation module 640 may enlarge or provide a zoomed view of the individual represented by the video feed in order to highlight a reaction, such as a facial feature, the individual had to the presenter. In some implementations, the presentation GUI 646 may include a video feed of a plurality of participants associated with a meeting, such as a general communication session. In other implementations, the presentation GUI 646 may be associated with a channel, such as a chat channel, enterprise Teams channel, or the like. Therefore, the presentation GUI 646 may be associated with an external communication session that is different from the general communication session.

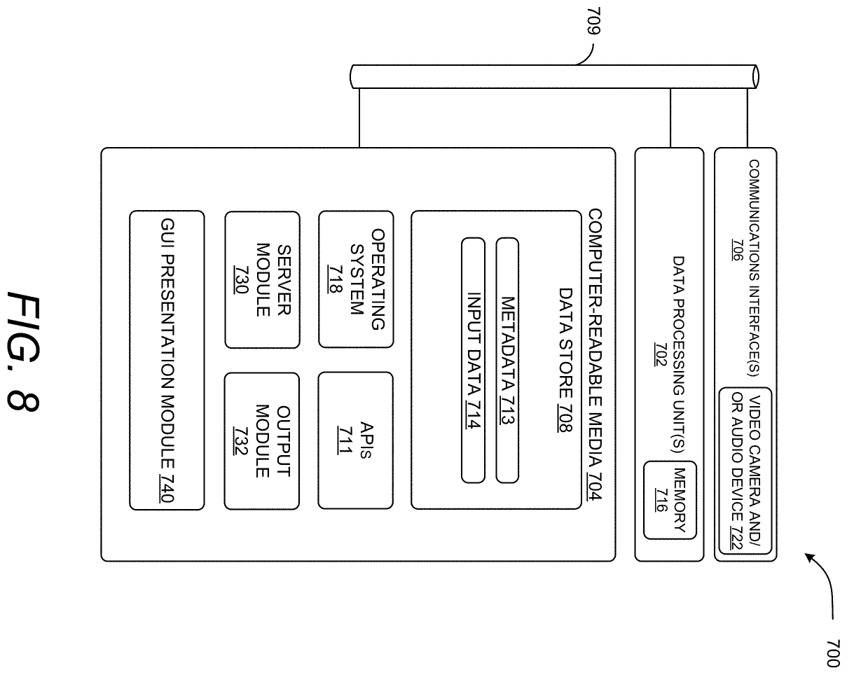

FIG. 8 illustrates a diagram that shows example components of an example device 700 (also referred to herein as a “computing device”) configured to generate data for some of the user interfaces disclosed herein. The device 700 may generate data that may include one or more sections that may render or comprise video, images, virtual objects, and/or content for display on the display screen 629. The device 700 may represent one of the device(s) described herein. The device 700 may represent one of any of the devices disclosed herein, e.g., device 606 of FIG. 7, device 11 of FIG. 1A, or a server 602 of FIG. 7.

As illustrated, the device 700 includes one or more data processing unit(s) 702, computer-readable media 704, and communication interface(s) 706. The components of the device 700 are operatively connected, for example, via a bus 709, which may include one or more of a system bus, a data bus, an address bus, a PCI bus, a Mini-PCI bus, and any variety of local, peripheral, and/or independent buses.

As utilized herein, data processing unit(s), such as the data processing unit(s) 702 and/or data processing unit(s) 692, may represent, for example, a CPU-type data processing unit, a GPU-type data processing unit, a field-programmable gate array (“FPGA”), another class of DSP, or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 704 and computer-readable media 694, may store instructions executable by the data processing unit(s). The computer-readable media may also store instructions executable by external data processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media, which might also be referred to herein as a computer-readable medium, may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device. The computer storage media can also be referred to herein as computer-readable storage media, non-transitory computer-readable storage media, non-transitory computer-readable medium, or computer storage medium.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se. In one example, the computer storage media can be block 704 in FIG. 8 or block 694 in FIG. 7.

Communication interface(s) 706 may represent, for example, network interface controllers (“NICs”) or other types of transceiver devices to send and receive communications over a network. Furthermore, the communication interface(s) 706 may include one or more video cameras and/or audio devices 722 to enable generation of video feeds and/or still images, and so forth.

In the illustrated example, computer-readable media 704, which can also be storage media, includes a data store 708. In some examples, the data store 708 includes data storage such as a database, data warehouse, or other type of structured or unstructured data storage. In some examples, the data store 708 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 708 may store data for the operations of processes, applications, components, and/or modules stored in computer-readable media 704 and/or executed by data processing unit(s) 702 and/or accelerator(s). For instance, in some examples, the data store 708 may store session data (e.g., session data 636 as shown in FIG. 7), metadata 713 (e.g., the data structure shown in FIG. 5), and/or other data such as input data 714, which can include voice commands, a mouse input, a touch input or other definitions of input gestures. The session data can include a total number of participants (e.g., users and/or client computing devices) in a communication session, activity that occurs in the communication session, a list of invitees to the communication session, and/or other data related to when and how the communication session is conducted or hosted. The data store 708 may also include contextual data, such as the content that includes video, audio, or other content for rendering and display on one or more of the display screens 629. Hardware data 711 can define aspects of any device, such as a number of display screens of a computer. The contextual data can define any type of activity or status related to the individual users 10A-10F each associated with individual video streams of a plurality of video streams 634. For instance, the contextual data can define a person's level in an organization, how each person's level relates to the level of others, a performance level of a person, or any other activity or status information that can be used to determine a position for a rendering of a person within a virtual environment.

Alternately, some or all of the above-referenced data can be stored on separate memories 716 on board one or more data processing unit(s) 702 such as a memory on board a CPU-type processor, a GPU-type processor, an FPGA-type accelerator, a DSP-type accelerator, and/or another accelerator. In this example, the computer-readable media 704 also includes an operating system 718 and application programming interface(s) (APIs) configured to expose the functionality and the data of the device 700 to other devices. Additionally, the computer-readable media 704 includes one or more modules such as the server module 730, the output module 732, and the GUI presentation module 740, although the number of illustrated modules is just an example, and the number may vary. That is, functionality described herein in association with the illustrated modules may be performed by a fewer number of modules or a larger number of modules on one device or spread across multiple devices.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method for managing message threads of a system, the method comprising:
causing a display of a user interface comprising an original thread of a plurality of messages, wherein an original message of the plurality of messages comprises text content;
causing the system to analyze text content of the original message to identify a first topic and a second topic within the text content of the original message of the plurality of messages, wherein a first text portion of the original message is associated with the first topic and a second text portion of the original message is associated with the second topic; and
responsive to the identification of the first topic and the second topic within the text content of the original message, causing the user interface to split the original thread and the original message by displaying a first message positioned in a first new thread and a second message positioned in a second new thread, wherein the first message comprises the first text portion of the original message that is associated with the first topic, and wherein the second message comprises the second text portion of the original message that is associated with the second topic.

2. The method of claim 1, wherein the user interface comprises a graphical element configured to invoke the analysis of the text content of the plurality of messages, wherein the method further comprises receiving a user input at the graphical element to cause analysis of the text content of the plurality of messages.

3. The method of claim 1, wherein the first new thread comprises a first display of messages that are each related to the first topic, wherein the first display of messages is arranged in a first alignment graphically indicating an association with the first topic, wherein the second new thread comprises a second display of messages that are each related to the second topic, wherein the second display of messages is arranged in a second alignment graphically indicating an association with the second topic.

4. The method of claim 1, wherein the analysis of the text content includes an identification of a first set of keywords that meet one or more criteria for an association with the first topic, and an identification of a second set of keywords that meet the one or more criteria for an association with the second topic.

5. The method of claim 1, wherein the method further comprises:
determining that a remote computing device does not meet one or more criteria for allowing the display of a user interface having a threshold number of topics; and
in response to determining that the remote computing device does not meet one or more criteria for allowing the display of the user interface having the threshold number of topics, causing a display of a second user interface comprising a number of message threads less than the threshold number of topics, wherein at least one thread comprises messages that include both the first portion of text content from the individual message associated with the first topic and the second portion of text content from the individual message associated with a second topic.

6. The method of claim 1, wherein the method further comprises: selecting the original message as an anchoring message from the plurality of messages of the original thread, wherein the selection of the original message is based on at least one of a position of the original message in the original thread relative to other messages in the original thread, a text format of content in the original message, a timestamp of the original message, an existence of a predetermined word in the original message, a state of composition of the original message, wherein the analysis of the text content of the original message is limited to the anchoring message.

7. The method of claim 1, wherein the method further comprises:
sending a split request to a remote computing device, the request identifying the first topic and the second topic, wherein the split request causes the remote computing device to deny the split request based on one or more factors;
receiving a new message from the remote computing device after the remote computing device denied the split request; and
analyzing content of the new message to determine if the new message is associated with the first topic, and in response to determining that the new message is associated with the first topic, displaying the new message within the first new thread displayed in the user interface.

8. The method of claim 1, wherein the split of the original thread is only performed in response to determining that the first topic or the second topic have associated scores that exceed a threshold priority score.

9. A method for managing message threads of a communication system, the method comprising:
cause a display of a user interface comprising an original thread of a plurality of messages, wherein an original message of the plurality of messages comprises text content;
receiving input gestures from an input device, wherein individual input gestures associate a first portion of the individual message with a first topic and associate a second portion of the individual message with a second topic; and
responsive to the input gestures associating the first portion of the individual message with the first topic and associating the second portion of the individual message with the second topic, causing an update to the user interface to replace the original thread with a first child thread and a second child thread, wherein the update to the user interface comprises a first message that is positioned in the first child thread and a second message that is positioned in the second child thread, the first message in the first child thread comprises the first portion of the individual message, and the second message in the second child thread comprises the second portion of the individual message.

10. The method of claim 9, wherein the input gestures identify the individual message as a selected message from the plurality of messages, wherein the selected message is analyzed for the identification of the first portion associated with the first topic and the identification of the second portion associated with the second topic, wherein conservation of computing resources is achieved by limiting the analysis to the selected message and not analyzing other messages of the original thread.

11. The method of claim 9, wherein the first child thread comprises a first display of messages that are each related to the first topic, wherein the first display of messages is arranged in a first alignment graphically indicating an association with the first topic, wherein the second child thread comprises a second display of messages that are each related to the second topic, wherein the second display of messages is arranged in a second alignment graphically indicating an association with the second topic.

12. The method of claim 9, wherein the method further comprises:
determining that a remote computing device does not meet one or more criteria for allowing the display of a user interface having a threshold number of topics; and
in response to determining that the remote computing device does not meet one or more criteria for allowing the display of the user interface having the threshold number of topics, causing a display of a second user interface comprising a number of message threads less than the threshold number of topics, wherein at least one thread comprises messages that include both the first portion of text content from the individual message associated with the first topic and the second portion of text content from the individual message associated with a second topic.

13. The method of claim 9, wherein the method further comprises: selecting the original message as an anchoring message from the plurality of messages of the original thread, wherein the selection of the original message is based on at least one of a position of the original message in the original thread relative to other messages in the original thread, a text format of content in the original message, a timestamp of the original message, an existence of a predetermined word in the original message, a state of composition of the original message, wherein an analysis of the text content of the original message for identifying the first portion and the second portion is limited to the anchoring message.

14. The method of claim 9, wherein the method further comprises:
sending a split request to a remote computing device, the request identifying the first topic and the second topic, wherein the split request causes the remote computing device to deny the split request based on one or more factors;
receiving a new message from the remote computing device after the remote computing device denied the split request; and
analyzing content of the new message to determine if the new message is associated with the first topic, and in response to determining that the new message is associated with the first topic, displaying the new message within the first new thread displayed in the user interface.

15. A computing device for managing message threads, comprising:
one or more processing units; and
a computer-readable storage medium having encoded thereon computer-executable instructions to cause the one or more processing units to:
cause a display of a user interface comprising an original thread of a plurality of messages, wherein an original message of the plurality of messages comprises text content;
analyze the text content of the original message to identify a first topic and a second topic within the text content of the original message of the plurality of messages, wherein a first text portion of the original message is associated with the first topic and a second text portion of the original message is associated with the second topic; and
responsive to the identification of the first topic and the second topic within the text content of the original message, cause the user interface to split the original thread and the original message by displaying a first message positioned in a first new thread and a second message positioned in a second new thread, wherein the first message comprises the first text portion of the original message that is associated with the first topic, and wherein the second message comprises the second text portion of the original message that is associated with the second topic.

16. The computing device of claim 15, wherein the user interface comprises a graphical element configured to invoke the analysis of the text content of the plurality of messages, wherein the method further comprises receiving a user input at the graphical element to cause analysis of the text content of the plurality of messages.

17. The computing device of claim 15, wherein the individual message arrangements each comprise a display of messages that are related to a common topic, the display of messages is arranged in an alignment graphically indicating the association of the common topic.

18. The computing device of claim 15, wherein analyzing the text content causes the identification of at least two topics, wherein the first child thread comprises a first display of messages that are each related to the first topic, wherein the first display of messages is arranged in a first alignment graphically indicating an association with the first topic, wherein the second child thread comprises a second display of messages that are each related to the second topic, wherein the second display of messages is arranged in a second alignment graphically indicating an association with the second topic.

19. The computing device of claim 15, wherein the instructions further cause the one or more processing units to:
determining that a remote computing device does not meet one or more criteria for allowing the display of a user interface having a threshold number of topics; and
in response to determining that the remote computing device does not meet one or more criteria for allowing the display of the user interface having the threshold number of topics, causing a display of a second user interface comprising a number of message arrangements less than the threshold number of topics, wherein the at least one arrangement of the number of message arrangements comprises messages that include both the portion of text content from the individual message associated with the first topic and the another portion of text content from the individual message associated with a second topic.

20. The computing device of claim 15, wherein the instructions further cause the one or more processing units to: select the original message as an anchoring message from the plurality of messages of the original thread, wherein the selection of the original message is based on at least one of a position of the original message in the original thread relative to other messages in the original thread, a text format of content in the original message, a timestamp of the original message, an existence of a predetermined word in the original message, a state of composition of the original message, wherein the analysis of the text content of the original message is limited to the anchoring message.
